(19) United States
(12) Patent Application Publication
(10) Pub. No.: US 2016/0131927 A1
(43) Pub. Date: May 12, 2016

(54) LIQUID CRYSTAL DISPLAY DEVICE

(71) Applicant: NITTO DENKO CORPORATION, Ibaraki-shi, Osaka (JP)

(72) Inventors: Shouhei Maesawa, Ibaraki-shi (JP); Kozo Nakamura, Ibaraki-shi (JP); Takehito Fuchida, Ibaraki-shi (JP); Hiroyuki Takemoto, Ibaraki-shi (JP)

(73) Assignee: NITTO DENKO CORPORATION, Ibaraki-shi, Osaka (JP)

(21) Appl. No.: 14/896,248

(22) PCT Filed: Jun. 3, 2014
(86) PCT No.: PCT/JP2014/064732

§ 371 Date: Dec. 4, 2015

(30) Foreign Application Priority Data
Jun. 7, 2013 (JP) 2013-120512

(51) Int. Cl. G02F 1/1335

(52) U.S. Cl. CPC G02F 1/1335; G02F 1/133524

(57) ABSTRACT

Provided is a liquid crystal display device that is narrow in viewing angle and that is capable of excellent image quality. The liquid crystal display device of the present invention includes: a liquid crystal panel; a prism sheet; a light guide plate; and a visible light absorber, which are provided in the stated order from a viewer side. The prism sheet has a convex portion on the opposite side from the viewer side. The visible light absorber has a luminous reflectance of 30% or less. In one embodiment, the liquid crystal display device of the present invention is free from a reflective polarizing plate. In one embodiment, the prism sheet includes a plurality of unit prisms, which are each shaped to have a triangular prism shape and which are arranged side by side.

### TECHNICAL FIELD

The present invention relates to a liquid crystal display device.

### BACKGROUND ART

Liquid crystal display devices are usually demanded to have a wide viewing angle when used in scenes where the viewer position is not fixed and the display device is supposed to be viewed from every angle (for example, in electronic advertisement and in television sets and personal computers for normal uses). To accomplish a wide viewing angle, various technologies that use a diffusion sheet, a prism sheet, a wide viewing angle liquid crystal panel, a wide viewing angle polarizing plate, or the like are being investigated. On the other hand, liquid crystal display devices that are capable of displaying an image at a narrow viewing angle (for example, liquid crystal display devices for use in cellular phones, notebook computers used in public places, automated teller machines, and seat monitors on rides) are also in demand for the prevention of screen peeking and other purposes when the viewer position is limited within a narrow range.

A technology of arranging a louver film on the viewer side of a liquid crystal display device (for example, Patent Literature 1) is known as a method of narrowing the viewing angle. Louver films control the viewing angle by blocking some of incident light, particularly light that has a large incident angle. However, using a louver film on a liquid crystal display device causes moiré patterns, streaks, hue fluctuations, and the like, which significantly degrade image quality. Another problem is that louver films are expensive.

### CITATION LIST

### Patent Literature

[PTL 1] JP 2009-528567 A

### SUMMARY OF INVENTION

### Technical Problem

The present invention has been made to solve the problems inherent in the related art, and an object of the present invention is therefore to provide a liquid crystal display device that is narrow in viewing angle and that is capable of excellent image quality.

### Solution to Problem

According to the present invention, there is provided a liquid crystal display device, including: a liquid crystal panel; a prism sheet; a light guide plate; and a visible light absorber, in which the liquid crystal panel, the prism sheet, the light guide plate, and the visible light absorber are provided in the stated order from a viewer side, in which the prism sheet includes a convex portion on an opposite side from the viewer side, and in which the visible light absorber has a luminous reflectance of 30% or less.

In one embodiment, the liquid crystal display device of the present invention is free from a reflective polarizing plate.

In one embodiment, the prism sheet includes a plurality of unit prisms, which are each shaped to have a triangular prism shape and which are arranged side by side.

In one embodiment, the light guide plate includes a prism shape formed on a back surface side and on the viewer side each.

### Advantageous Effects of Invention

According to the embodiments of the present invention, the liquid crystal display device narrow in viewing angle and capable of excellent image quality may be provided by including the prism sheet that is convex on the opposite side (back surface side) from the viewer side and the visible light absorber that is arranged on the back surface side of the light guide plate. More specifically, replacing a reflecting plate that is arranged on the back surface side of a light guide plate in a liquid crystal display device of the related art with the visible light absorber helps the prism sheet that is arranged so as to be convex on the back surface side exert a light condensing effect to a markedly high level, thereby enabling the liquid crystal display device to narrow the viewing angle without using a louver film. With no need for a louver film, the liquid crystal display device of the embodiments of the present invention also has excellent image quality and may be provided inexpensively.

### BRIEF DESCRIPTION OF DRAWINGS

FIG. 1 is a schematic sectional view of a liquid crystal display device according to one embodiment of the present invention.

FIG. 2 is a diagram for illustrating a direction at a polar angle of 40° in at least one direction within an exit plane in a liquid crystal display device of the present invention.

FIG. 3 is a schematic perspective view of a prism sheet that is used in one embodiment of the present invention.

FIG. 4(a) to FIG. 4(g) are graphs for showing the viewing angle characteristics of liquid crystal display devices according to Examples and liquid crystal display devices according to Comparative Examples.

### DESCRIPTION OF EMBODIMENTS

Now, embodiments of the present invention are described with reference to the drawings. However, the present invention is not limited to these embodiments.

A. Entire Construction of Liquid Crystal Display Device

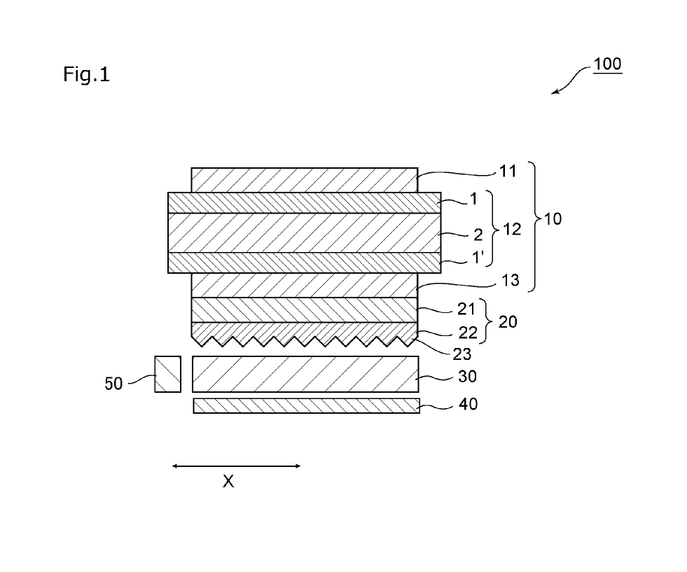

FIG. 1 is a schematic sectional view of a liquid crystal display device according to one embodiment of the present invention. A liquid crystal display device 100 includes a liquid crystal panel 10, a prism sheet 20, a light guide plate 30, and a visible light absorber 40 in the stated order from the viewer side. The liquid crystal panel 10 typically includes a liquid crystal cell 12, a viewer-side polarizing plate 11, which is arranged on the viewer side of the liquid crystal cell 12, and a back surface-side polarizing plate 13, which is arranged on the back surface side of the liquid crystal cell. The prism sheet 20 has a convex portion on the opposite side (back surface side) from the viewer side. The light guide plate 30 and the visible light absorber 40 in one embodiment can be members constructing a backlight unit. The backlight unit in practice can further include any other appropriate members. For example, the backlight unit can further include a light source 50. An edge-lit backlight unit, where a light source is provided on a side surface, is preferred in the present invention. The liquid crystal display device may further include any other appropriate members.

The present invention can provide a liquid crystal display device that is narrow in viewing angle owing to an incident light condensing function of the prism sheet that has a convex portion on the back surface side. The light condensing function of the prism sheet is enhanced by arranging the visible light absorber in place of a reflecting plate that is included in a liquid crystal display device (substantially a backlight unit) of the related art. As a result, a viewing angle as narrow as, or narrower than, that of a liquid crystal display device of the related art that uses a louver film is achieved and image quality far superior to that of the liquid crystal display device of the related art that uses a louver film is accomplished. These effects are obtained presumably because the visible light absorber suppresses reflection that occurs remarkably at the reflecting plate, which is the corresponding component in the related art. While prism sheets that have a convex portion on the viewer side are a commonly known optical member that has a light condensing function, combining a visible light absorber with a prism sheet that has a convex portion on the viewer side does not enhance the light condensing function of the prism sheet. This is presumably because the prism sheet having a convex portion on the viewer side is likely to reflect light from the light guide plate to the back surface side, which makes a reflecting plate that re-reflects the light reflected to the back surface side indispensable in order to secure a necessary amount of exit light and to exert the light condensing function.

A preferred liquid crystal display device of the present invention does not include a reflective polarizing plate. A liquid crystal display device that is even narrower in viewing angle and that is high in luminance is obtained in the present invention by not including a reflective polarizing plate. In one embodiment, no reflective polarizing plate is provided between the prism sheet and the back surface-side polarizing plate of the liquid crystal panel, that is, the prism sheet is provided directly on the liquid crystal panel. A liquid crystal display device that is even narrower in viewing angle and that is high in luminance is obtained in the present invention by not including a reflective polarizing plate and eliminating reflection that would otherwise be repeated between the reflective polarizing plate and the visible light absorber. The present invention, which is capable of obtaining a liquid crystal display device high in image quality and narrow in viewing angle without needing a reflective polarizing plate, is also advantageous in terms of cost. The expression “directly provided” herein includes bonding one member and another member with each other via a pressure-sensitive adhesive or an adhesive.

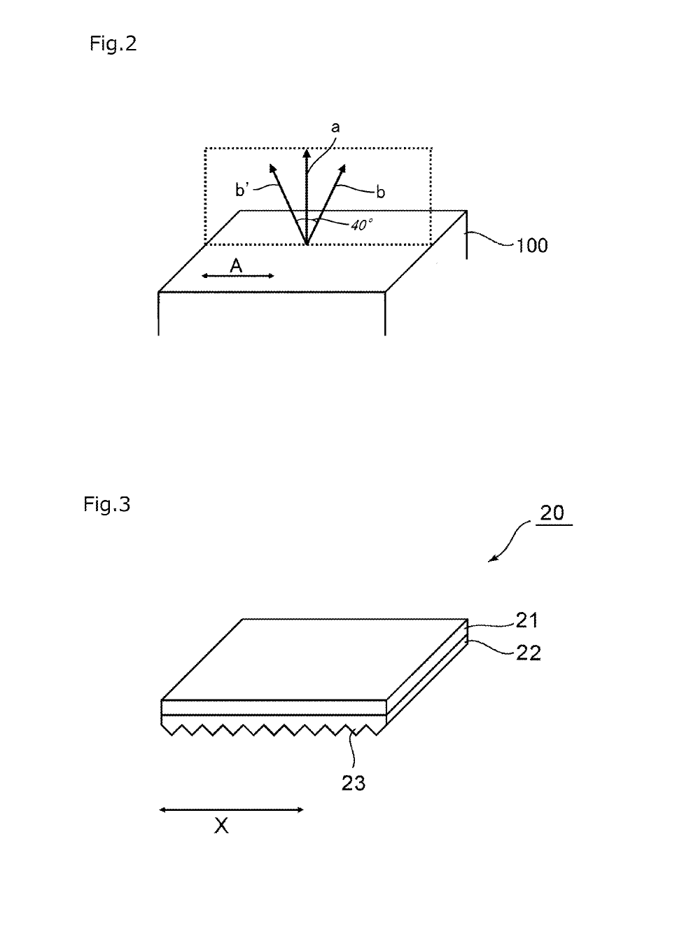

In the liquid crystal display device of the present invention, a luminance at a polar angle of 40° (directions b and b′ in FIG. 2) in at least one direction (for example, a direction A in FIG. 2) within an exit plane is preferably 10% or less of the luminance in a front direction (polar angle: 0°, a direction a in FIG. 2), more preferably 8% or less, particularly preferably from 1% to 5%. A liquid crystal display device having this luminance range possesses viewing angle characteristics that are preferred for a liquid crystal display device that has a function of preventing screen peeking. The direction in the exit plane in which the preferred luminance at a polar angle of 40° of exit light is within the range given above is a direction in which a reduction in viewing angle is desired, for example, a direction in which the screen peeking preventing effect is to be exerted. In the case where the prism sheet is constructed from columnar unit prisms as described later, this direction can be a direction that is substantially perpendicular to the lengthwise direction (ridge line direction) of each unit prism. The polar angle herein refers to an angle formed by the normal line direction (front direction) of the liquid crystal display device and exit light from the liquid crystal display device.

B. Liquid Crystal Panel

The liquid crystal panel 10 typically includes the liquid crystal cell 12, the viewer-side polarizing plate 11, which is arranged on the viewer side of the liquid crystal cell 12, and the back surface-side polarizing plate 13, which is arranged on the back surface side of the liquid crystal cell. The viewer-side polarizing plate 11 and the back surface-side polarizing plate 13 can be arranged so that an absorption axis of the viewer-side polarizing plate 11 and an absorption axis of the back surface-side polarizing plate 13 are substantially perpendicular or parallel to each other.

B-1. Liquid Crystal Cell

The liquid crystal cell 12 includes a pair of substrates 1 and 1′ and a liquid crystal layer 2 as a display medium sandwiched between the substrates. In a general configuration, on one of the substrates, a color filter and a black matrix are provided, and on the other substrate, there are provided switching elements for controlling electro-optical property of the liquid crystal, scanning lines for giving gate signals to the switching elements and signal lines for giving source signals thereto, and pixel electrodes and a counter electrode. An interval (cell gap) between the above-mentioned substrates can be controlled by spacers and the like. On sides of the above-mentioned substrates, which are brought into contact with the liquid crystal layer, for example, alignment films made of polyimide or the like can be provided.

In one embodiment, the liquid crystal layer includes liquid crystal molecules aligned in a homogeneous alignment in a state where an electric field is not present. The liquid crystal layer (liquid crystal cell as a result) as described above typically exhibits a three-dimensional refractive index of nx>ny=nz. Note that, ny=nz herein includes not only a case where ny and nz are completely the same, but also a case where ny and nz are substantially the same. As a typical example of a drive mode using the liquid crystal layer that exhibits the three-dimensional refractive index as described above, the in-plane switching (IPS) mode, the fringe field switching (FFS) mode, and the like are given. Note that, the above-mentioned IPS mode includes the super in-plane switching (S-IPS) mode and the advanced super in-plane switching (AS-IPS) mode, each of which employs a V-shaped electrode, a zigzag electrode, or the like. The above-mentioned FFS mode includes the advanced fringe field switching (A-FFS) mode and the ultra fringe field switching (U-FFS) mode, each of which employs a V-shaped electrode, a zigzag electrode, or the like.

In another embodiment, the liquid crystal layer includes liquid crystal molecules aligned in a homeotropic alignment in the state where no electric field is present. The liquid crystal layer (liquid crystal cell as a result) as described above typically exhibits a three-dimensional refractive index of nz>nx=ny. As a drive mode using the liquid crystal molecules aligned in the homeotropic alignment in the state where no electric field is present, for example, the vertical alignment (VA) mode is given. The VA mode includes the multi-domain VA (MVA) mode.

B-2. Polarizing Plate

The polarizing plate typically includes a polarizer, and protective layers arranged on both sides of the polarizer. The polarizer is typically an absorption-type polarizer.

The transmittance of the above-mentioned absorption-type polarizer (also referred to as a single axis transmittance) at the wavelength of 589 nm is preferably 41% or more, more preferably 42% or more. Note that, the theoretical upper limit of the single axis transmittance is 50%. In addition, polarization degree thereof is preferably from 99.5% to 100%, more preferably from 99.9% to 100%. As long as the polarization degree falls within the range, contrast in the front direction can be further higher when using the liquid crystal display device.

Any appropriate polarizer may be adopted as the polarizer. Examples thereof include a polarizer obtained by uniaxially stretching a hydrophilic polymer film such as a polyvinyl alcohol-based film, a partially formalized polyvinyl alcohol-based film, or an ethylene-vinyl acetate copolymer-based partially saponified film in which a dichroic substance such as iodine or a dichroic dyestuff has been adsorbed, and a polyene-based alignment film such as a product obtained by subjecting polyvinyl alcohol to dehydration treatment or a product obtained by subjecting polyvinyl chloride to dehydrochlorination treatment. Of those, a polarizer obtained by uniaxially stretching a polyvinyl alcohol-based film in which a dichroic substance such as iodine has been adsorbed is particularly preferred for its high polarized dichroic ratio. The thickness of the polarizer is preferably from 0.5 μm to 80 μm.

The polarizer that is a uniaxially-stretched polyvinyl alcohol-based film in which iodine is adsorbed is prepared typically by immersing polyvinyl alcohol-based film in an aqueous solution of iodine, thus dyeing the film, and stretching the film to a length three to seven times the original length of the film. The film may be stretched after the dyeing, or may be stretched while being dyed, or may be dyed after the stretching. The preparation of the film includes, other than the stretching and the dyeing, such treatment as swelling, cross-linking, adjustment, water washing, and drying.

Any appropriate film is used as the protective film. Specific examples of a material serving as a main component of such a film include transparent resins such as a cellulose-based resin such as triacetylcellulose (TAC), a (meth)acrylic resin, a polyester-based resin, a polyvinyl alcohol-based resin, a polycarbonate-based resin, a polyamide-based resin, a polyimide-based resin, a polyether sulfone-based resin, a polysulfone-based resin, a polystyrene-based resin, a polynorbornene-based resin, a polyolef in-based resin, and an acetate-based resin. Another example thereof is a thermosetting resin or a UV-curable resin such as an acrylic resin, a urethane-based resin, an acrylic urethane-based resin, an epoxy-based resin, or a silicone-based resin. Still another example thereof is a glassy polymer such as a siloxane-based polymer. Further, a polymer film described in JP 2001-343529 A (WO 01/37007 A1) may also be used. As a material for the film, for example, there may be used a resin composition containing a thermoplastic resin having a substituted or unsubstituted imide group in a side chain and a thermoplastic resin having a substituted or unsubstituted phenyl group and a nitrile group in a side chain. An example thereof is a resin composition containing an alternate copolymer formed of isobutene and N-methylmaleimide and an acrylonitrile-styrene copolymer. The polymer film may be an extruded product of the resin composition, for example.

C. Prism Sheet

FIG. 3 is a schematic perspective view of a prism sheet that is used in one embodiment of the present invention. The prism sheet 20 typically includes a base material portion 21 and a prism portion 22. The base material portion 21 may be omitted, depending on what member is adjacent to the prism sheet 20.

The prism sheet 20 can be bonded to a member adjacent to the prism sheet 20 through any appropriate adhesion layer (such as an adhesive layer or a pressure-sensitive adhesive layer: not shown).

C-1. Prism Portion

The prism sheet 20 (substantially the prism portion 22) in one embodiment is constructed from a plurality of unit prisms 23, which are arranged side by side to one another and are convex on the opposite side (back surface side) from the viewer side as illustrated in FIG. 1 and FIG. 3. Arranging the prism sheet 20 with its convex portion facing toward the back surface side facilitates the condensation of light transmitted through the prism sheet 20. In addition, less light is reflected instead of entering the prism sheet 20 when the prism sheet 20 is arranged with its convex portion facing toward the back surface side than when the convex portion faces toward the viewer side, and a liquid crystal display device having high luminance is obtained as a result.

A preferred shape of each of the unit prisms 23 is a columnar shape. The prism sheet constructed from the unit prisms that are columnar condenses transmitted light in a unit prism alignment direction X, namely, a direction that is substantially perpendicular to the lengthwise direction (ridge line direction) of each of the unit prisms. Any appropriate shape can be adopted as the sectional shape of each of the unit prisms 23 as long as the effects of the present invention are obtained. The sectional shape of each of the unit prisms 23 in a section parallel to its arrangement direction and parallel to its thickness direction may be a triangular shape (i.e., the unit prism has a triangular prism shape) or may be any other shape (e.g., such a shape that one of, or each of both, the inclined planes of a triangle has a plurality of flat surfaces having different tilt angles). The triangular shape may be a shape asymmetric with respect to a straight line passing the apex of the unit prism and perpendicular to the surface of the sheet (e.g., a scalene triangle), or may be a shape symmetric with respect to the straight line (e.g., an isosceles triangle). Further, the apex of the unit prism may be of a chamfered curved surface shape, or may be of a shape whose section is a trapezoid, the shape being obtained by such cutting that its tip becomes a flat surface. Detailed shapes of the unit prisms can be appropriately set depending on purposes. For example, a construction described in JP 11-84111 A can be adopted for each of the unit prisms. The expressions “substantially perpendicular” and “approximately perpendicular” herein include a case where an angle formed by two directions is 90°±10°, preferably 90°±7°, more preferably 90°±5°. The expressions “substantially parallel” and “approximately parallel” include a case where an angle formed by two directions is 0°±10°, preferably 0°±7°, more preferably 0°±5°. Moreover, such a simple expression “perpendicular” or “parallel” herein can include a substantially perpendicular state or a substantially parallel state.

The lengthwise direction (ridge line direction) of each of the unit prisms 23 is preferably a direction that is approximately perpendicular to a transmission axis of the back surface-side polarizing plate 13. It should be noted that the prism sheet 20 may be arranged so that the ridge line direction of each of the unit prisms 23 and the transmission axis of the back surface-side polarizing plate 13 may form a predetermined angle (the so-called oblique placement). The range of the oblique placement is preferably 20° or less, more preferably 15° or less.

C-2. Base Material Portion

When the prism sheet 20 is provided with the base material portion 21, the base material portion 21 and the prism portion 22 may be integrally formed by, for example, subjecting a single material to extrusion molding, or the prism portion may be shaped on a film for the base material portion. The thickness of the base material portion is preferably from 25 μm to 150 μm.

Any appropriate material can be adopted as a material constituting the base material portion 21 depending on purposes and the construction of the prism sheet. When the prism portion is shaped on the film for the base material portion, the film for the base material portion is specifically, for example, a film formed of cellulose triacetate (TAC), a (meth)acrylic resin such as polymethylmethacrylate (PMMA), or a polycarbonate (PC) resin. The film is preferably an unstretched film.

When the base material portion 21 and the prism portion 22 are integrally formed of a single material, the same material as a material for forming the prism portion when the prism portion is shaped on the film for the base material portion can be used as the material. Examples of the material for forming the prism portion include epoxy acrylate—and urethane acrylate-based reactive resins (such as an ionizing radiation-curable resin). When the prism sheet of an integral construction is formed, a polyester resin such as PC or PET, an acrylic resin such as PMMA or MS, or an optically transparent thermoplastic resin such as cyclic polyolefin can be used.

It is preferred that the base material portion 21 substantially have optical isotropy. The phrase “substantially have optical isotropy” herein means that a retardation value is so small as to have substantially no influences on the optical characteristics of the liquid crystal display device. For example, an in-plane retardation Re of the base material portion is preferably 20 nm or less, more preferably 10 nm or less. It should be noted that the in-plane retardation Re is an in-plane retardation value measured at 23° C. with light having a wavelength of 590 nm. The in-plane retardation Re is represented by the equation “Re=(nx−ny)xd.” Here, nx represents a refractive index in the direction in which a refractive index becomes maximum in the surface of the optical member (i.e., a slow axis direction), ny represents a refractive index in a direction vertical to the slow axis in the surface (i.e., a fast axis direction), and d represents the thickness (nm) of the optical member.

Further, the photoelastic coefficient of the base material portion 21 is preferably from −10×10⁻¹² m²/N to 10×10⁻¹² m²/N, more preferably from −5×10⁻¹² m²/N to 5×10⁻¹² m²/N, still more preferably from −3×10⁻¹² m²/N to 3×10⁻¹² m²/N.

D. Light Guide Plate

Any appropriate light guide plate can be used. Examples of appropriate light guide plates include a light guide plate in which a lens pattern is formed on the back surface side so that light from a lateral direction can be polarized in the thickness direction, and a light guide plate in which a prism shape or the like is formed on the back surface side and/or the viewer side. A light guide plate in which a prism shape is formed on the back surface side and the viewer side each is preferred. The ridge line direction of the prism shape formed on the back surface side and the ridge line direction of the prism shape formed on the viewer side are preferably perpendicular to each other in this light guide plate. Using this or a similar light guide plate causes light that is easily condensed to enter the prism sheet described above, and heightens the effects of the present invention.

E. Visible Light Absorber

The visible light absorber absorbs visible light that exits from the light guide plate to the back surface side. “Visible light” herein refers to light having a wavelength of from 380 nm to 750 nm.

The luminous reflectance of the visible light absorber is 30% or less, preferably 20% or less, more preferably from 1% to 10%. Setting the visible light absorber to this range of luminous reflectance narrows the viewing angle appropriately, and the resultant liquid crystal display device possesses viewing angle characteristics that are preferred in, for example, a liquid crystal display device that has a function of preventing screen peeking. The luminous reflectance of the visible light absorber can be adjusted to suit a desired viewing angle or luminance. Specifically, dropping the luminous reflectance narrows the viewing angle and raising the luminous reflectance increases the luminance. “Luminous reflectance” herein is the reflectance of the Y value in the XYZ color system, and is a reflectance measured in conformity to JIS Z 8722.

Any appropriate material that has a luminous reflectance within the above-mentioned range can be used to form the visible light absorber. Specific examples of the material of the visible light absorber include a piece of paper painted black, a resin film colored black, and a metal film colored black. The resin film colored black is, for example, a combination of a base polymer such as an acrylic resin, an acetal-based resin, or a chloroprene rubber, and a colorant such as a pigment, dyestuff, or carbon black. Other specific examples of the resin film colored black include a resin film formed by applying black paint to a reflective or transmissive resin film, and a resin film formed by adhering an inorganic substance to a reflective or transmissive resin film. Examples of the metal film colored black include a metal film formed by applying black paint to a reflective metal film, a metal film formed by adhering an inorganic substance to a reflective metal film, and a metal film on which any appropriate type of surface treatment has been performed, such as an aluminum film treated by black alumite treatment.

The thickness of the visible light absorber is preferably from 0.01 mm to 20 mm, more preferably from 0.01 mm to 10 mm, particularly preferably from 0.02 mm to 5 mm, most preferably from 0.02 mm to 1 mm.

F. Backlight unit

The light guide plate and the visible light absorber in one embodiment can be members that construct a backlight unit. The backlight unit in practice can further include a light source.

The light source is arranged in a place that corresponds to a side surface of the light guide plate. The light source can be, for example, an LED light source that includes an array of a plurality of LEDs.

The backlight unit can further include other members. For example, the backlight unit can further include any appropriate diffusion plate if necessary.

G. Uses

The liquid crystal display device of the present invention is favorably applied to uses where displaying an image at a narrow viewing angle is demanded. Specific examples of uses where the liquid crystal display device of the present invention is preferred include seat monitors, which are provided on the outer backs of chairs (seats) on rides such as vehicles, trains, ships, and planes, automated teller machines, ticket machines and other vending machines, and portable terminals. In addition to the use as a seat monitor on a ride, the liquid crystal display device of the present invention can be installed on the wall, floor, or ceiling of a ride.

When the liquid crystal display device of the present invention is used as a seat monitor, a high quality image can be viewed at a position in front of the seat monitor where a view of the monitor screen is desired, whereas images on the monitor screen are difficult to view from other positions, and the fear of annoying those who do not want to watch is thus reduced.

### EXAMPLES

The present invention is specifically described below by way of examples, but the present invention is not limited to these examples. Testing and evaluating methods in the examples are as follows. Moreover, unless particularly specified, “parts” and “%” in the examples are weight-based units.

(1) Luminous Reflectance

The luminous reflectances of visible light absorbers used in Examples and of reflecting plates used in Comparative Examples were measured by a method conforming to JIS Z 8722, with the use of a spectrophotometer “U-4100”, a product of Hitachi High-Technologies Corporation.

(2) Luminance

A white screen was displayed on liquid crystal display devices obtained in Examples and in Comparative Examples, and a luminance meter (“Conoscope”, a product of AUTRONIC-MELCHERS GmbH) was used to measure the luminance in all directions at a polar angle θ ranging from 0° to 80°.

(3) Image Quality

A given image was displayed on the liquid crystal display devices to conduct an unaided visual check for graininess, moiré patterns, and blurring in the image.

### Example 1

A liquid crystal display device was prepared that included, from the viewer side in order, a liquid crystal panel (the liquid crystal panel mounted to a VAIO S-series computer manufactured by Sony Corporation, configuration: viewer-side polarizing plate/TN-mode liquid crystal cell/back surface-side polarizing plate), a prism sheet, and a backlight unit.

The prism sheet used includes a base material portion and a prism portion in which a plurality of unit prisms each having a triangular prism shape are aligned. The prism sheet was arranged so that its convex portion faced toward the back surface side.

The backlight used includes a light guide plate, an LED light source, which is arranged in a place corresponding to a side surface of the light guide plate, and a visible light absorber (construction paper “C-855”, a product of Daio Paper Corporation, luminous reflectance: 70), which is arranged on the back surface side of the light guide plate.

The luminance of the obtained liquid crystal display device was measured by the evaluation method (2) described above. The luminance measured in the front direction (at a polar angle of 0°) is shown in Table 1.

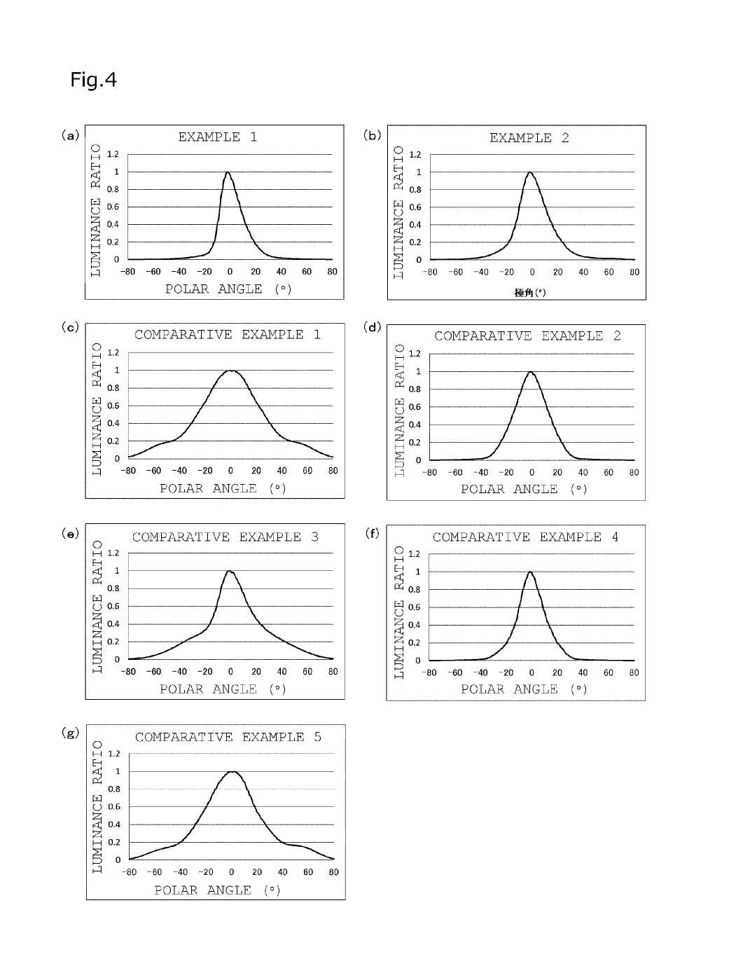

The ratio of a corrected luminance at the polar angle θ to a corrected luminance in the front direction in a direction within an exit plane that has the narrowest viewing angle is shown in a graph of FIG. 4(a). The ratio of the luminance at a polar angle of 40° to the luminance in the front direction (at a polar angle of 0°) which is obtained from this graph is shown in Table 1. A corrected luminance is a value calculated by multiplying a measured luminance by the cosine value of the polar angle θ (cos θ) at the measurement point in order to correct an error that is due to the location of the measurement.

The image quality of the obtained liquid crystal display device was checked by the evaluation method (3) described above, to reveal that fine image quality without visible graininess, moiré patterns, and blurring was acquired.

### Example 2

A liquid crystal display device was prepared in the same way as in Example 1, except that a reflective polarizing plate was arranged between the liquid crystal panel and the prism sheet. The resultant liquid crystal display device was evaluated by the same method that was used in Example 1. Results thereof are shown in Table 1 and FIG. 4 (b). The image quality of the obtained liquid crystal display device was checked by the evaluation method (3) to reveal that fine image quality without visible graininess, moiré patterns, and blurring was acquired.

### Comparative Example 1

A liquid crystal display device was prepared that included, from the viewer side in order, a liquid crystal panel (the liquid crystal panel mounted to an iPad2 manufactured by Apple Inc., configuration: viewer-side polarizing plate/IPS-mode liquid crystal cell/back surface-side polarizing plate), a reflective polarizing plate, a first diffusion sheet, a first prism sheet, a second prism sheet, a second diffusion sheet, and a backlight unit (the edge-lit backlight unit including a light guide plate having hemispherical lenses formed thereon, a white PET reflecting plate (luminous reflectance: 99%), and an LED light source).

The first and second prism sheets used include a base material portion and a prism portion in which a plurality of unit prisms each having a triangular prism shape are aligned. The prism sheets were each arranged so that its convex portion faced toward the viewer side. The first prism sheet and the second prism sheet were arranged so that the alignment direction in the first prism sheet and the alignment direction in the second prism sheet were perpendicular to each other.

The resultant liquid crystal display device was evaluated by the same method that was used in Example 1. Results thereof are shown in Table 1 and FIG. 4(d). The image quality of the obtained liquid crystal display device was checked by the evaluation method (3) to reveal that fine image quality without visible graininess, moiré patterns, and blurring was acquired.

### Comparative Example 2

A liquid crystal display device was prepared in the same way as in Comparative Example 1, except that a louver film (“Security/Privacy Filter”, a product of Sumitomo 3M Limited, thickness: 0.6 mm, louver portion width: 7 μm, light transmitting portion width: 150 μm) was further included on the viewer side of the liquid crystal panel.

The louver film was arranged so that an effect axis direction (a direction in which the viewing angle is narrowed) of the louver film was parallel to the direction in which the unit prisms of the first prism sheet were aligned, and so that the effect axis direction of the louver film was perpendicular to the LED alignment direction.

The resultant liquid crystal display device was evaluated by the same method that was used in Example 1. Results thereof are shown in Table 1 and FIG. 4(d). The image quality of the obtained liquid crystal display device was checked by the evaluation method (3) to reveal that visible graininess, moiré patterns, and blurring were recognized and fine image quality was not acquired.

### Comparative Example 3

A liquid crystal display device was prepared that included, from the viewer side in order, a liquid crystal panel (the liquid crystal panel mounted to a VAIO S-series computer manufactured by Sony Corporation, configuration: viewer-side polarizing plate/TN-mode liquid crystal cell/back surface-side polarizing plate), a reflective polarizing plate, a prism sheet, and a backlight unit (the edge-lit backlight unit including a light guide plate having a prism shape formed thereon, a white PET reflecting plate (luminous reflectance: 99%), and an LED light source).

The prism sheet used includes a base material portion and a prism portion in which a plurality of unit prisms each having a triangular prism shape are aligned. The prism sheet was arranged so that its convex portion faced toward the back surface side.

The resultant liquid crystal display device was evaluated by the same method that was used in Example 1. Results thereof are shown in Table 1 and FIG. 4(e). The image quality of the obtained liquid crystal display device was checked by the evaluation method (3) to reveal that fine image quality without visible graininess, moiré patterns, and blurring was acquired.

### Comparative Example 4

A liquid crystal display device was prepared in the same way as in Comparative Example 3, except that a louver film (“Security/Privacy Filter”, a product of Sumitomo 3M Limited, thickness: 0.6 mm, louver portion width: 7 μm, light transmitting portion width: 150 μm) was further included on the viewer side of the liquid crystal panel.

The louver film was arranged so that an effect axis direction (a direction in which the viewing angle is narrowed) of the louver film was parallel to the direction in which the unit prisms were aligned, and so that the effect axis direction of the louver film was perpendicular to the LED alignment direction.

The resultant liquid crystal display device was evaluated by the same method that was used in Example 1. Results thereof are shown in Table 1 and FIG. 4(f). The image quality of the obtained liquid crystal display device was checked by the evaluation method (3) to reveal that visible graininess, moiré patterns, and blurring were recognized and fine image quality was not acquired.

### Comparative Example 5

A liquid crystal display device was prepared in the same way as in Comparative Example 1, except that a visible light absorber (construction paper “C-855”, a product of Daio Paper Corporation, luminous reflectance: 7%) was used in place of the white PET reflecting plate (luminous reflectance: 99%).

The resultant liquid crystal display device was evaluated by the same method that was used in Example 1. Results thereof are shown in Table 1 and FIG. 4(g). The image quality of the obtained liquid crystal display device was checked by the evaluation method (3) to reveal that fine image quality without visible graininess, moiré patterns, and blurring was acquired.

TABLE 1

| | Prism | Visible light absorber | | | | Luminance (at | | |
|---|---|---|---|---|---|---|---|---|
| | sheet | or reflecting plate | | | | polar angle of | | Luminance |
| | convex | | Luminous | | Reflective | 40°)/Luminance | | in front |
| | portion | | reflectance | Louver | polarizing | (at polar angle of | Image | direction |
| | direction | | (%) | film | plate | 0°) | quality | (cd/m²) |
| Example 1 | Back | Visible | 7 | Not | Not | 0.01-0.02 | ∘ | 252 |
| | surface | light | | included | included | | | |
| | side | absorber | | | | | | |
| Example 2 | Back | Visible | 7 | Not | Included | 0.03-0.04 | ∘ | 214 |
| | surface | light | | included | | | | |
| | side | absorber | | | | | | |
| Comparative | Viewer | White | 99 | Not | Included | 0.25 | ∘ | 388 |
| Example 1 | side | reflecting | | included | | | | |
| | | plate | | | | | | |
| Comparative | Viewer | White | 99 | Included | Included | 0.02 | x | 293 |
| Example 2 | side | reflecting | | | | | | |
| | | plate | | | | | | |
| Comparative | Viewer | White | 99 | Not | Included | 0.18-0.21 | ∘ | 289 |
| Example 3 | side | reflecting | | included | | | | |
| | | plate | | | | | | |
| Comparative | Viewer | White | 99 | Included | Included | 0.02 | x | 220 |
| Example 4 | side | reflecting | | | | | | |
| | | plate | | | | | | |
| Comparative | Viewer | Visible | 7 | Not | Included | 0.19-0.21 | ∘ | 51 |
| Example 5 | side | light | | included | | | | |
| | | absorber | | | | | | |

As is apparent from Table 1 and FIG. 4(a) to FIG. 4(g), a liquid crystal display device that is narrowed in viewing angle in a favorable manner can be obtained according to the present invention. Specifically, a comparison of Example 1 and Example 2 with Comparative Example 2 and Comparative Example 4 clearly indicates that, despite not using a louver film, a liquid crystal display device of the present invention is successful in narrowing the viewing angle as much as, or more than, a liquid crystal display device that includes a louver film. The liquid crystal display device of the present invention is also capable of as high image quality as a liquid crystal display device that does not include a louver film.

In addition, a comparison between Example 1 and Example 2 clearly indicates that a liquid crystal display device that is narrow in viewing angle and high in luminance is obtained in the present invention by not including a reflective polarizing plate.

These effects are obtained by combining a prism sheet that has a convex portion on the back surface side with a visible light absorber. As indicated by Comparative Example 5, using a prism sheet that has a convex portion on the viewer side does not help in narrowing the viewing angle and lowers the luminance significantly.

### REFERENCE SIGNS LIST

10 liquid crystal panel
20 prism sheet
30 light guide plate
40 visible light absorber
100 liquid crystal display device

1. A liquid crystal display device, comprising:
a liquid crystal panel;
a prism sheet;
a light guide plate; and
a visible light absorber,
wherein the liquid crystal panel, the prism sheet, the light guide plate, and the visible light absorber are provided in the stated order from a viewer side,
wherein the prism sheet comprises a convex portion on an opposite side from the viewer side, and
wherein the visible light absorber has a luminous reflectance of 30% or less.

2. The liquid crystal display device according to claim 1, wherein the liquid crystal display device is free from a reflective polarizing plate.

3. The liquid crystal display device according to claim 1, wherein the prism sheet comprises a plurality of unit prisms, which are each shaped to have a triangular prism shape and which are arranged side by side.

4. The liquid crystal display device according to claim 1, wherein the light guide plate comprises a prism shape formed on a back surface side and on the viewer side each.
